(19) United States
(12) Patent Application Publication
(10) Pub. No.: US 2006/0093523 A1
(43) Pub. Date: May 4, 2006

(54) System, method and apparatus for mud-gas extraction, detection and analysis thereof

(75) Inventor: James T. Norman, Tyler, TX (US)

Correspondence Address: R. SCOTT RHOADES;WINSTEAD SECHREST & MINICK P.C., PO BOX 50784, DALLAS, TX, 75201, US

(73) Assignee: Hyperteq, LP, Arlington, TX (US)

(21) Appl. No.: 10/977,427

(22) Filed: Oct. 29, 2004

(51) Int. Cl. G01N 30/00

(52) U.S. Cl. 422/83; 436/25

(57) ABSTRACT

The application of a gas analyzer for gas mud logging is presented to measure gases in the return mud flow used in drilling processes. A supported membrane extraction probe from the analyzer is inserted into the mud flow. The probe extracts target gases from the mud through the membrane. Extracted gases are transported by an internal pump to an internal gas sensor unit. The infrared sensor unit is utilized to subject the gases to infrared emitted energy to excite the gasses at a molecular level for sensing and detection. The sensor then transfers sensed values electronically to a digital conditioning board. As the data is digitized in the conditioning board it is encoded with information to enable a means of correlating the derived sensor data. The data is then sent to a digital wireless transceiver for transport to a remote receiving transceiver connected to a microprocessor for data logging.

### FIELD OF INVENTION

This invention relates to systems for analyzing the concentration of gases dissolved in a media matrix. In particular this invention relates to an extraction sensor system for extracting, measuring, analyzing, and communicating target gas concentrations used in oil and gas well-site applications.

### BACKGROUND OF THE INVENTION

The analysis of formation gases returned to the surface in drilling fluids has been an important first appraisal of a potential reservoir zone, providing important data to guide subsequent evaluation and testing. The tremendous value of this data source has been its immediacy. Specifically, reservoir zones can be evaluated while they are being penetrated for the first time. This prevents post-drilling changes to the formation that can limit the effectiveness of many other evaluation techniques. Knowing the presence and concentration of hydrocarbon gases in drilling fluids provide an indication of the formation confronted by the drill bit and provides a basis for determining the feasibility of obtaining oil and gas from the well. The desirability of taking formation fluid and other samples for chemical and physical analysis has long been recognized by oil companies for many years. These samples are typically collected as early as possible in the life of a reservoir for analysis at the surface and, more particularly, in specialized laboratories. The information that such analysis provides is vital in the planning and development of hydrocarbon reservoirs, as well as in the assessment of a reservoir's capacity and performance.

Furthermore, if formations become invaded or damaged after they are drilled, or if tools cannot reach the zone of interest, initial analysis may provide the only reasonable data by which to evaluate a well. Despite this, the evaluation provided by gas analysis is often over-looked and misunderstood. This results from the qualitative and inconsistent nature of the data stemming from the way that the gas sample is extracted for analysis. In oil and gas exploration, several techniques are used to determine whether deposits of oil and/or natural gas exist at a particular site.

One process to extract samples is known as well bore sampling. The process involves the lowering of a sampling tool, such as a formation testing tool into the actual well bore to collect a sample or multiple samples of formation fluid by engagement between a probe member of the sampling tool and the wall of the well bore. The sampling tool creates a pressure differential across such engagement to induce formation fluid flow into one or more sample chambers within the sampling tool.

One method to determine whether drilling operations should be continued at a particular site involves the analysis of gases contained within the drilling mud used in the drilling operation. In most drilling operations, drilling mud is circulated around the drill bit during the drilling operation. This mud is circulated to the surface of the drill site and carries with it debris and cuttings resulting from drilling.

In some devices highly sophisticated and temperamental equipment is used for detecting and analyzing these gases. One example is the wireline logging apparatus. However, although the manner of acquisition of this data is widespread in the petroleum industry, wireline logging has long had the reputation of being an unreliable source of data with inconsistent results. The inconsistencies result largely from the way that the gas is extracted from the drilling fluid.

In addition, virtually unchanged throughout history, is the process known as mud logging. Through mud logging, dissolved gas is broken out of solution by applying a form of agitation to the mud. The released gas is then held within a trap and transported to a remote gas analyzer by a flow of air. There are many variables and inconsistencies in this process that result in a purely qualitative gas measurement and leave important questions unanswered. Namely, how much gas is actually present in the drilling fluid and what exactly is the composition.

Conventional gas extraction means and methods currently utilize a motorized impeller placed in the returned mud matrix to physically agitate the gas out of the mud. The mud is then transported via long tube lines to a remote gas analyzer for analysis. The current problems with these methods are the obvious long gas transport tubes that introduce a delay lag and possible condensate contamination, as well as the use of power cords required for the process operation. These lines and cords are exposed to potential tripping, electrocution and possible fire hazards. Conventional agitation extractors are also subject to gas sample contamination due to varying mud levels and environmental variables such as wind blowing past the agitator and temperature fluctuations. All of these factors lead to possible erroneous gas volumes, dilutions and or contaminations leading to false or erroneously variable gas sensing and measurement processes.

In addition, other current conventional gas sensing and detection means and methods utilize a “hotwire” CCD (catalytic combustion detector) and or a TCD (thermal conductivity detector). These types of sensors can be a very accurate and efficient means of gas detection. However, by nature of design, these detectors require a super heated wire that is exposed to the gas media for sensing. This direct contact method of sensing, when utilized in mud gas sensing, introduces many new variables and potential errors and or failures. The sensed mud gas matrix not only contains target hydrocarbon gases but variable contaminates such as hydrogen sulfides and silicones which tend to degrade or foul typical “hotwire” type detectors, causing them to respond erroneously and potentially fail altogether. This typical sensor application mismatch leads to high equipment replacement rates as well as undependable data measurement when exposed to certain environmental variables.

The disclosure herein provides a different approach to the problems above. Specifically, progressive thought has led developers of the present invention to conclude that these approaches were very restrictive, cumbersome, inaccurate, and inefficient. More, specifically the gas sensing and analysis system of the present invention not only solves the numerous short comings and problems associated with conventional gas extraction and sensing and detection components, but it incorporates all of the individual conventional component level processes into a single compact and highly efficient portable and/or autonomous unit. The present invention's design frees the unit from power and process requirements and restrictions, leading to a more reliable and efficient gas sample collection, sensing and analysis system.

### SUMMARY OF INVENTION

It is a principal object of the present invention to provide a system, apparatus and method for in field high quality mud-gas extraction, sensing, detection, measurement and analysis.

In one or more embodiments of the present invention the application of a mud-gas extraction system and apparatus for the specific purpose of gas mud logging is utilized to analyze gas-in-mud in the return flow of mud used in the drilling process. As a drill advances into a borehole, removal cuttings from the borehole are returned with the original feed mudflow to the surface. The resultant is a media matrix of clean feed mud and borehole cuttings. A semi-permeable membrane, housed within an extraction probe is then inserted in the return mud matrix. By the specific nature of the membrane, the probe starts to extract target gases from the mud matrix. Extracted target gases are then transported along protected tubing by an internal airflow pump to an internal gas detector. As part of the detection process, the gasses are then subjected to an infrared emitted energy that excites the gasses at a molecular level, thereby causing the gas molecules to vibrate, wherein they absorb/lose a portion of the emitted infrared energy. The lost or absorbed energy is then monitored by an infrared sensor.

The sensed values are then transferred electronically to a digital conditioning board, where the values are corrected for any erroneous information, scaled to a common engineering unit and digitized. The gas-sensed units are then sent to a digital wireless RF modem for transport to a receiving RF modem connected to a computer for further data logging to permanent media storage, display monitoring and or printer plotting. This data can be further analyzed as both quantitative as well as qualitative data, thus giving the well owner an insight in to the type of gas, quality of gas and the quantities relative to the drilled borehole. In addition, as the sensor data is digitized, this data is encoded along with the specific date, time and depth stamp to enable a means of correlating the derived sensor data.

Therefore, it is an object of one or more embodiments of the present invention to provide a gas extraction system that provides for maximum system extraction efficiency by utilizing semi-permeable silicone membranes.

It is a further object of one or more embodiments of the present invention to provide a system for gas sensing by use of non-contact infrared absorption via emitters and detectors.

It is another object of the invention to provide a system, apparatus and method which analyzes and provides qualitative and quantitative determinations of at least the various hydrocarbon gases evolving from a well via at least the mud matrix.

Furthermore, it is a further object of one or more embodiments of the present invention to provide a system for wirelessly communicating bi-directional control and data acquisition information that overall facilitates quick, accurate and effortless analysis of gas-in-mud concentrations and other valuable data.

It should be understood that anyone of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF DRAWINGS

Many of the aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. A preferred embodiment of these parts will be described in detail in the specification and illustrated in the accompanying drawings, which forms a part of this disclosure. For a more complete understanding of the present invention, and the advantages thereof, reference is now made to the following descriptions taken in conjunction with the accompanying drawings, in which:

FIG. 1 is depiction of a gas sensor and analyzer system according to the present invention;

FIG. 2 is a depiction of a gas analyzer unit apparatus and its assorted internal components according to the present invention.

FIG. 3 is a depiction of a mandrel supported membrane gas extraction probe with a associated machined mandrel according to the present invention;

FIG. 4 is a graphical depiction of a membrane gas extraction process as utilized according to the present invention.

FIG. 5 is a graphical depiction of a photo-absorbent IR sensor cell and its operation according to the present invention.

FIG. 6 is a depiction of an encoder component module apparatus according to the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

In oil and gas drilling operations, drilling mud is continuously circulated into and out of the well to the drill bit to facilitate the drilling operation. When the drill bit reaches a formation containing hydrocarbon gases, these gases mix in a solution with the mud and then surface with it. The present invention provides a mud gas extraction system, apparatus and method for providing real-time accurate gas extraction, detection, and sensing and other information for wellsite gas-in-mud analysis. Through detection of the hydrocarbon gases, the presence of oil and/or gas can be determined among other valuable information.

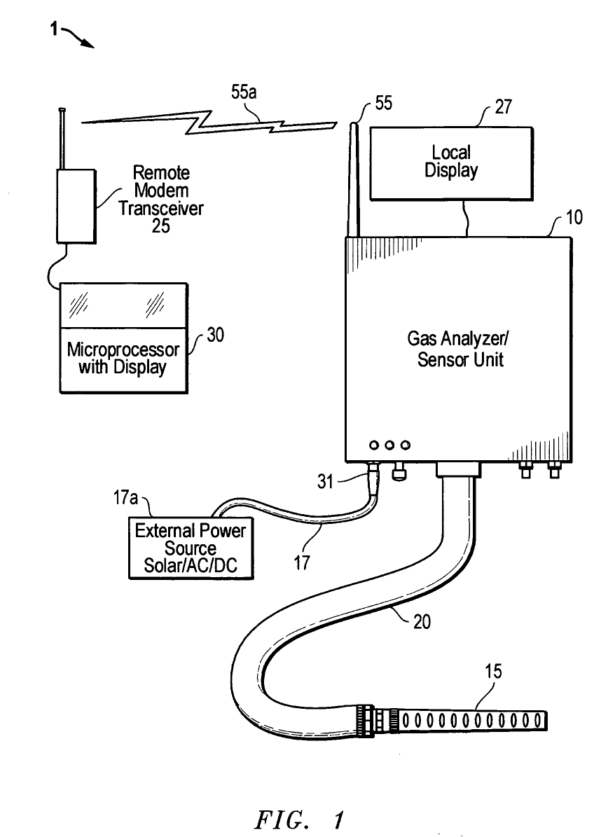

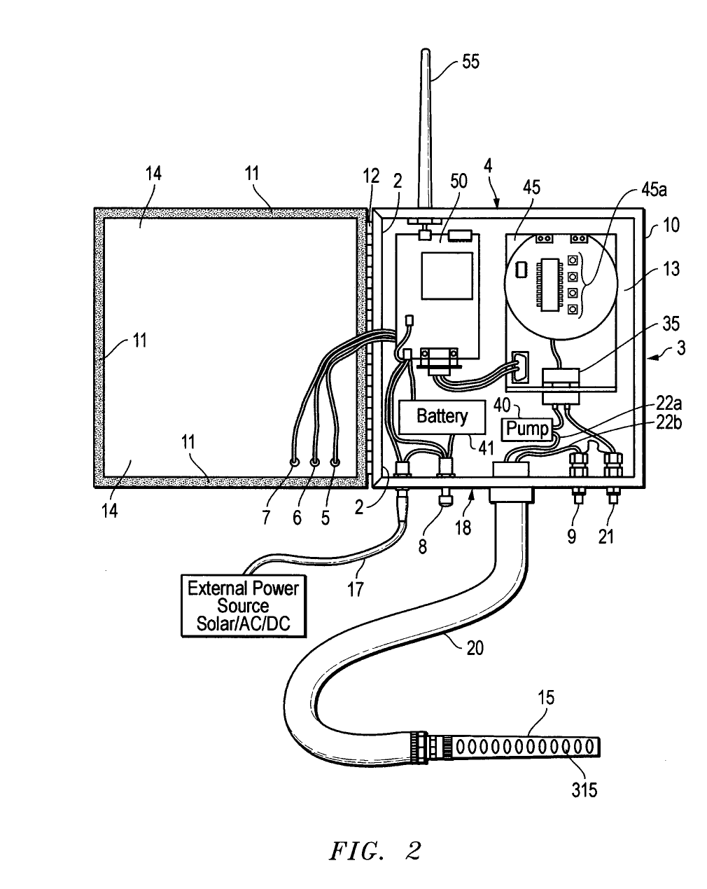

FIG. 1 illustrates the combination gas extraction and analyzer system 1 according to the present invention used for mud gas extraction, detection, and sensing of hydrocarbon gases in the drilling mud. The system 1 comprises a gas analyzer sensing unit 10 (described hereinbelow in detail in reference to FIG. 2), wherein a flow cell mud-gas extraction probe 15 (described in detail hereinbelow in reference to FIG. 2) is removably connected to the gas analyzer sensing unit 10 via a flexible hose 20 portion (further described below). The gas analyzer sensing unit 10 of the present invention can be powered by a plurality of external power sources 17a, such as, but not limited to sources such as AC, DC provided by battery, and solar and is connected thereto by appropriate electrical lead 17 via the system external power port connector 31. According to one embodiment of the present invention, a 12VDC power source is provided by a 12VDC, 5.2 Ah internal rechargeable battery 41 (see item 41 shown in FIG. 2). A power switch 8 (see FIG. 2) is provided for applying operating power to unit 10.

In further reference to FIG. 1, the gas analyzer sensing unit 10 of system 1 is capable of wirelessly communicating gas-sensed unit information to at least a microprocessor 30 via spread-spectrum radio frequency (RF) bi-directional communications 55a. According to the present invention a laptop can be utilized as the receiving microprocessor 30 but as will be appreciated by those skilled in the art, it will be understood that a laptop is not meant to be limiting on the type of receiving microprocessors available for use with the present system 1. An example of a laptop as utilized in one embodiment of the current invention is available from Dell Computer. Some of the specifications regarding the laptop 30 utilized with one embodiment of the present invention are as follows:
Mobile Intel® Celeron® Processor at 2.20 GHz with on-die 256 KB L2 cache and 400 MHz front side bus
Operating Systems: Microsoft® Windows® 98 or higher
   256 or 512 MB shared DDR SDRAM
   266 MHz bus frequency
   3-USB 2.0 (Universal Serial Bus) compliant 4-pin connectors
   Video: 15-pin monitor connector
   10/100 Ethernet LAN: RJ-45 connector
   Modem: RJ-11 connector
   Chassis14.1″ XGA display
   8-cell Nickel Metal Hydride battery (43 Whr)

The gas analyzer sensing unit 10 further comprises at least one internally disposed digital wireless RF modem transceiver (not shown in FIG. 1, see 50 shown in FIG. 2), communicably coupled to a remote mount high gain RF antenna 55 for wirelessly transmitting data via spread-spectrum bi-directional communications 55a to a receiving remote RF modem 25 communicably connected to a microprocessor 30 for data logging to permanent media storage, display monitoring and/or printer plotting.

The system 1 further comprises a local display 27 apparatus in communication with the gas sensing unit 10 and the microprocessor 30 for communicating and displaying specific gas volumes, gas concentrations, and for providing in field calibration of the gas sensing unit 10.

Referring now to FIG. 2, wherein the gas analyzer sensing unit 10 is shown depicting its specific contained components and sub-modules for use in gas mud-logging and area gas monitoring or other gas sensing and detection applications. The gas analyzer sensing unit 10 of the present invention provides application as a gas analyzer sensing unit 10 for gas mud logging to measure the return flow of gases in the mud matrix used in the drilling process.

As shown in FIG. 2 the gas analyzer sensing unit 10 is housed by a stainless steel, or other suitable material, housing 13 adapted to comprise and enclose and/or permit attachment thereto associated components such as an IR sensor head assembly 35 with accompanying sensor conditioning electronics board 45. An example of the IR sensor head assembly as utilized in one embodiment of the current invention is available from Dynament Limited, UK having a part number of HHC-NC. The specifications regarding the IR sensor head assembly 35 are as follows:
Power Requirements: 5V d.c. max. 60 mA max. (50% duty cycle)
Measuring range: 0-100% vol. Propane
Resolution: ≦1% vol. Propane
Warm up time: To final zero ±1%: <20 s @20° C. ambient
To specification: <30 minutes @20° C. ambient
Response Time: T90<30s @20° C. ambient
Zero Repeatability: ±1% vol. Propane @20° C. ambient
Span Repeatability: ±1% vol. Propane @20° C. ambient
Long term zero drift: ±0.05% vol. Propane per month @20° C. ambient
Industrial Range Commercial Range
Ambient temperature range: Storage −20° C. to +50° C. (−4° F. to 122° F.)
Operating −20° C. to +50° C. (−4° F. to 122° F.)
Storage −20° C. to +50° C. (−4° F. to 122° F.)
Operating 0° C. to +40° C. (32° F. to 104° F.)
Humidity range: 0 to 95% RH non-condensing. Negligible effect at 30% Vol. Propane
MTBF >5 years
Temperature compensation Integral thermistor for temperature monitoring
Height: Standard version 16.6 mm, excluding pins.
Sub-miniature version 14 mm, excluding pins.
Diameter: 20 mm

The electronic sensor conditioning micro-processor board 45 as utilized in one embodiment of the current invention is available from Dynament Limited, UK having a part number of OEM1 with HHC-NC sensor.

The board module 45 requires a dc power supply and provides all the hardware and embedded software necessary to drive the sensor 35, extract the signals and convert them into a linearised analogue output proportional to gas concentration information. The specifications and features regarding the electronic sensor conditioning board 45 are as follows:
Compact design for use within standard explosion proof enclosures
Quickest route into the Infrared market
High resolution 12 bit A-D converter
Regulated lamp drive circuit
Pushbutton operation and onboard LCD for simple set-up and calibration only
4-20 mA analogue output, 10 bit, with current limit and polarity protection
Data collection mode and RS232 data output facility remote monitoring and data logging
Polarity protected input for single 8-30V, 70 mA dc supply
Optional sensor mounting and gas sampling adaptor

The circuitry of the conditioning board 45 provides a regulated, 4 Hz. square-wave drive to the sensor's 35 lamp. The resulting signals from the sensor's 35 detector and reference outputs are amplified to a suitable level and processed by an A/D converter therein. Using the program appropriate to the type of sensor selected by the user, a microcontroller uses the signals from the sensor 35 to provide a linearised drive to the analogue output circuit.

In order to calibrate the board module 45, it is necessary to present a “zero” gas sample and a “span” gas sample to the sensor 35. Provided thereon conditioning board 45 are four pushbuttons 45a and a four digit display for enabling the user to select from the following options:
Sensor type select i.e. Carbon Dioxide, Methane etc.
Sensor zero mode
Sensor span mode
Analogue Output zero mode
Analogue Output span mode
Run mode
Data observation mode.

In the analyzer 10, gas sensed values are transferred electronically to the sensor digital conditioning electronics board 45, where the values are corrected for any erroneous variables, scaled to a common engineering unit and digitized. The signal conditioning electronics 45 provides necessary amplification, filtering, converting, and other processes required to make the IR sensor cell assembly's 35 output suitable for reading by computer boards. Essentially, the signal conditioning electronics 45 are primarily utilized for data acquisition, in which sensor cell assembly 35 signals must be normalized and filtered to levels suitable for analog-to-digital conversion so they can be read by a microprocessor 30.

The gas-sensed values are then sent to a digital wireless RF modem transceiver 50 (see FIG. 2) for transport to a receiving remote gateway module consisting of an electronic RF transceiver modem 25 (shown in FIG. 1) connected to a microprocessor 30 for further data logging to permanent media storage, display monitoring and or printer plotting. This data can be further analyzed as both quantitative as well as qualitative data, thus giving the well owner an insight in to the type of gas, quality of gas and the quantities relative to the drilled borehole.

The modem 25 is provided with power back up supplied by a DC battery source. In addition, remote mounted high gain antenna is disposed on the modem 25 enclosure for communicating with analyzer unit's 10 transceiver modem 50 (described below). The remote modem 25 comprises a plurality of software program modules, wherein the modules are programmed to provide microprocessor functionality control and to provide user interface functionality and control.

Unit 10 further comprises an internal RF wireless communication transceiver modem 50 and associated electronics for providing signal control and acquisition communications to the remote gateway module RF transceiver modem 25 (described above) for bi-directional control and data acquisition. It should be understood by one skilled in the art that it is within the scope of the present invention to combine all component and sub-module electronic boards into one unitized master control board for each unit 10. An example of the RF wireless communication transceiver modem 50 as utilized in one embodiment of the present invention is available from MaxStream of Lindon, Utah having a part number of xc09-038 nsc. Some of the specifications and features regarding the RF wireless communication transceiver modem 50 are as follows:

Long Range:
300 ft. (90 m) indoor/urban environments
1000 ft. (300 m) line-of-sight w/ dipole
108 dBm receiver sensitivity

Low Power:
55 mA transmit/35 mA receive current consumption
Power down mode 20 μA
2.85 VDC to 5.50 VDC interface
Plug-and-communicate (no configuration required)

Additional features of the RF wireless communication transceiver modem 50 include the following:
Transparent operation supports existing software & systems
Simple configuration using software & standard AT commands
Simple UART interface
RS-232/422/485 protocol support
Multi-drop bus support
True peer-to-peer networking (no “Master” radio needed)
Support for point-to-point & point-to-multipoint networks
Up to 65,000 network addresses available
Allows up to 7 Frequency Hopping Spread Spectrum independent pairs (networks) to operate in close proximity
Single channel mode for low latency with 12 selectable channels
RF data rate of 10000 bps or 41666 bps
Host interface baud rates from 1200 bps to 57600 bps
XON/XOFF or hardware flow control
Signal strength reporting for link quality monitoring & debugging
Support for multiple data formats (7/8 bits, Even/Odd/No Parity)
Frequency—902-928 MHz
Spreading Spectrum Type—Frequency hopping, direct FM
Network Topology—Peer-to-peer, point-to-multipoint, point-to-point, multi-drop transparent

Configuration of the RF wireless communication transceiver modem 50 of the present invention is not required. The serial data from any microcontroller or RS-232 port is output into the transceiver modem 50 to send FCC and IC approved, single channel or frequency hopping spread spectrum data.

In further reference to FIG. 2, an air/gas transfer pump assembly 40 is shown in Flow Communication wire tubes 22 for providing at least 2700 cc/min free flow at 11 psig of outside air to and across the flow cell membrane 315 (described below) via air intake orifice 9 and return extracted gas from the flow cell membrane 315 to the IR sensor assembly 35 for sensing and detection. In addition, the pump 40 provides gas exhaust externally to the unit 10 via gas exhaust orifice 21. The air/gas transfer prime mover pump assembly 40 as utilized in one embodiment of the current invention is available from Sensidyne, Inc. of Clearwater, Fla. having a part number of 801522. The specifications and features regarding the air/gas transfer pump assembly 40 are as follows:
Rated Voltage—6 volts DC
Maximum Power Consumption—1.7 watts
Free Flow @ rated voltage—2700 cc/min
Maximum Dead Head Pressure—11 psig

In further reference to FIG. 2, housing 13 is shown as being fabricated having a plurality of vertical walls comprising two vertical side walls 2, 3 and a vertical front wall 18 and a vertical rear wall 4, thereby forming a housing depth of approximately 2-3 inches. Furthermore, a horizontally disposed back side portion (not shown) is integrally formed to the bottom edges of the two vertical side walls 2, 3 and the vertical front wall 18 and vertical rear wall 4 to form a cavity housing 13 for containing internal unit 10 components. Housing 13 is further configured with a front-side door 14 portion, wherein the front-side door 14 is hingeably 12 attached to the top edge of vertical side wall of housing 13. The front-side door 14 is further provided with a sealing member 11, such as a rubber gasket seal, or the like, to protect the unit's 10 internal components from the environment. Furthermore, for positional stability during field use, unit 10 is provided with an aluminum tripod mounting fixture and tripod (both not shown).

Front-side door 14 also provides a plurality of system LEDs disposed for viewing when front-side door 14 is closed for displaying at least system power indications 5, system transmit indications 6, and system receive indications 7. Furthermore, the vertical front wall 18 comprises the air intake orifice 9 and a gas exhaust 21 orifice as described above.

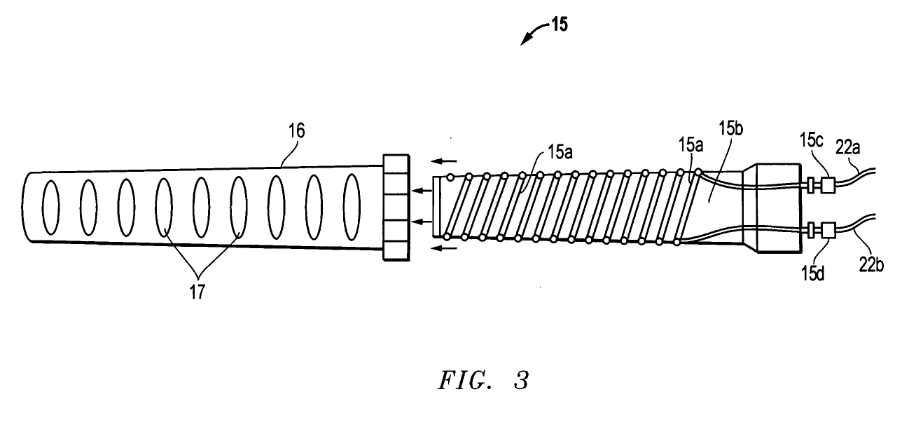

In reference to FIGS. 2 and 3 the flow cell mud-gas extraction probe 15 is illustrated. According to the present invention, the probe 15 is designed for extraction and detection of hydrocarbon gases found in drilling mud. However, it must be understood by one skilled in the art that the probe and extraction system combination can have other gas extraction and sensing applications outside of the drilling environment. The flowcell gas extraction probe 15 is designed as a gas extraction tool for manual insertion into a mud flow matrix, or for insertion into a closed loop system, for the purpose of conducting gas sensing, detection and analysis. The extraction probe 15 mandrel as utilized in at least one embodiment of the present invention is available from Global FIA, Inc. of Fox Island, Wash.

The flowcell gas extraction probe assembly 15, as shown in FIGS. 1 and 2, is preferably of modular construction comprising a supported silicon membrane tubing 15a wrapped around a support mandrel 15b that is inserted into a cylindrically shaped stainless steel machined mandrel 16 for protection and support. In addition the mandrel 16 provides a surface for a plurality of machine formed flow channel slots 17 to facilitate gas from media extraction. The probe assembly 15 is connected to a six foot rubber connecting/shielding hose 20, wherein the hose 20 operates to protectively enclose two six foot stainless air flow supply/return lines 22 that are interconnected to connectors 15c, 15d and interconnected with pump 40 and air intake 9. The probe assembly 15 hose 20 and tubes 22a/b combination is removably attached to the gas analyzer sensing unit 10 described above via standard connection means as is known in the art.

Now describing the operation of probe assembly 15, as a well drill advances into a well borehole removal cuttings from the borehole are returned with the original feed mudflow and returned to the surface. At this point a media matrix of clean feed mud and borehole cuttings are present. Probe assembly 15 is then positioned for mud-gas extraction and detection by inserting the probe assembly 15 into a mud ditch formed by the circulated mud from the well. As will be appreciated by those skilled in the art, it will be understood that the probe assembly 15 may be positioned either in a mud ditch designed to carry the circulating mud away from the drill site or in a mud tank where the drilling mud is collected prior to disposal or recirculation or in a closed loop assembly system.

By the specific nature of the membrane 15a (described below), the probe 15 begins to extract target gases from the mud matrix as airflow transfer pump 40 provides a fresh air circulation stream across the membrane 15a flowcell disposed in the probe 15 while also providing an extracted gas circulation stream across the IR sensor head assembly 35 for direct gas sensing. It should be understood by one skilled in the art that it is within the scope of the present invention to combine the flowcell gas extraction probe 15 and the IR sensor assembly 35 into one module unit. Such design provides for reduced manufacturing processes and increased performance capabilities.

The present invention improves the quality of data through the use of such a membrane 310 system by removing the problem at the source. This is accomplished by positioning a flow cell mud-gas extraction probe 15 directly into a returning mudstream, wherein the probe 15 has a membrane supported on a structured mandrel, wherein a path is created to provide flow exposure to both sides of the supported membrane.

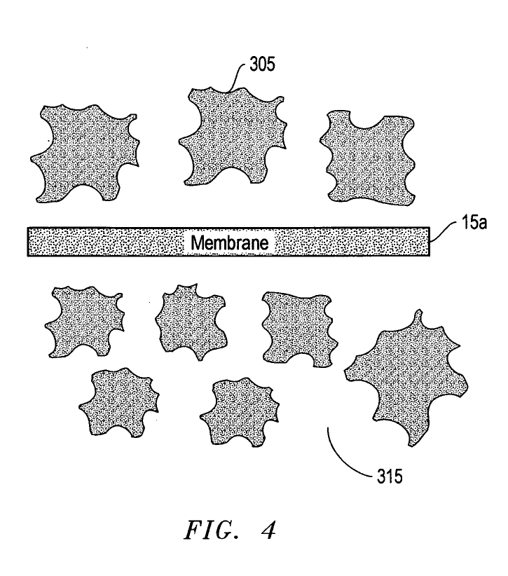

Turning now to FIG. 4, the present invention employs a semi-permeable silicon membrane 15a, shown graphically positioned with respect to the matrix side 305 and the sensor side 315 as depicted in FIG. 4, wherein the membrane 15a is housed within insertion probe assembly 15 (See FIG. 3), that is designed to be positioned directly within a returning mud stream as previously described. The semi-permeable silicon membrane 15a of the present invention permits the extraction of gas vapors from the matrix side 305 and supplies the gas to the sensor side 315 for providing IR sensing and detection and analysis of quantitative data by unit 10 that benefits both formation evaluation and drilling safety. The quantitative measurement is derived regardless of whether the gas is dissolved or present as bubbles (free gas). By using semi-permeable membrane 15a technology, the present invention provides for a more accurate determination, by volume, of gas in liquid. Advantageously, the present invention provides for analysis at the point of extraction, which provides rapid resolution as compared to modern conventional systems.

Semi permeable membranes 15a are generally considered to be impermeable to liquids, while permeable to gases. Gas permeation through the membrane 15a wall is driven by the difference in the partial pressures, the pressure outside the membrane 15a wall and the pressure inside of that particular gas. Essentially, membrane 15a can be defined as a barrier, which separates two phases, the matrix side phase 305 and the sensor side phase 315, and restricts transport of various matter in a selective manner.

The present invention provides for at least the following permeability of organics in silicone rubber membranes.

Permeability, cm3 cm/s cm2 cm Hg (x 106)

Alkanes
Methane 0.13
Ethane 0.33
Propane 0.80
Butane 1.0
Pentane 6.9
Hexane 8.8
Heptane 22
Aromatic Hydrocarbons
Benzene 13
Toluene 27
Ethylbenzene 42
Chloromethanes
Chlormethane 1.9
Dichloromethane 9.7
Chloroform 12
Carbon Tetrachloride 12
Chlorethylenes
Chloroethylene 1.6
1,1-dichloroethylene 8.0
Trichloroethylene 18
Tetrachloroethylene 45
Bromomethanes
Bromomethane 1.9
Dibromomethane 16
Bromoform 67
Alcohols
Methanol 5.3
Ethanol 11
1-propanol 13
1-butanol 14

Generally, in the application of hydrocarbon gas extraction and detection in drilling fluids, polydimethylsiloxane silicone (PDMS) is generally chosen as the membrane material and is processed at different thicknesses to improve its selectivity to hydrocarbons. Silicones are used for their high selectivity in separation as absorbent with fixed pore size. By reducing the thickness of the polymer, improvements in membrane performances are observed. According to its composition, silicone exhibits different surface properties. For separation by pervaporation, the focus is on their hydrophobic properties. For the extraction of hydrocarbons from liquids by pervaporation, hydrophobic silicones such as PDMS suggest good selectivity as permeation membranes, acting as a molecular sieve (described below).

Pervaporation is utilized in the membrane based process in which the matrix 305 is maintained at atmospheric pressure on the feed or upstream side of the membrane 15a, wherein the permeate is removed as a vapor because of a low vapor pressure existing on the permeate or downstream side. This low (partial) vapor pressure can be achieved by employing a carrier gas or using a transfer pump as shown in FIG. 2 item 40. The (partial) downstream pressure must be lower than the saturation pressure at least.

The present invention discloses a mud-gas extraction technique, wherein a hydrophobic silicone membrane is supported on a structured mandrel 15a (shown in FIG. 3) such that a path is created to provide flow exposure to both sides, the matrix side 305 and a sensor side 315, of the supported membrane 15a as is graphically depicted in FIG. 4. On the upstream face, the matrix side 305, a flow of entrained liquid, mud and gas is applied. Then a clean supply of air 322 is applied to the downstream face to facilitate gas transport across the membrane 310. This gas is then supplied to a sensor detector 35 for measurement (described below).

According to an embodiment of the present invention, a hybrid Zeolite-filled silicon membrane (ZSM) molecular sieve flowcell gas extraction technique is used with the present invention. Zeolite-filled hybrid silicone membranes have gained increasing attention in the separation processes of liquid to hydrocarbons entrainments via pervaporation technique as described above. The separation by this hybrid silicone membrane process is based on the difference in the permeation rates of the hydrocarbons, which are selectively sorbed via the membrane upstream face. The process is industrially used for hydrocarbon dehydration and is an attractive means for the extraction of hydrocarbons from liquids. It uses silicone matrix polymers with strong affinity to the hydrocarbons to be preferentially permeated.

For hydrocarbon extraction from liquids, silicone is generally chosen as the membrane material. To enhance its selectivity to hydrocarbons, the silicone can be filled with a Zeolite. Zeolites are used for their high selectivity in catalysis or in separation as a sieve with fixed pore size. Zeolites as fillers have been shown to convey excellent selectivity and permeation flux to standard silicone membranes such that they can act as a molecular sieve. The organic molecules can sieve through Zeolite pores and reach the downstream side of the membrane via less convoluted paths than most liquid molecules, resulting in gas/liquid extraction technique.

Improvements in membrane performance have been observed by mixing the membrane with a polymer. According to its composition, Zeolites exhibit different surface properties. For the extraction of hydrocarbons from liquids by pervaporation, hydrophobic Zeolites such as ZSM-5 or silicalite-1 as fillers convey good selectivity and permeation flux to silicone membranes, acting as a molecular sieve. The present invention has determined that the organic molecules can sieve through Zeolite pores and reach the downstream side of the membrane via less convoluted paths than most liquid molecules, resulting membrane performances depend strongly on the Zeolite properties.

As utilized in the present invention, the molecular sieving properties of silicalite-1 filler exhibited that the hybrid membrane's selectivity to hydrocarbons increases with the silicon/aluminum (Si/Al) ratio of the ZSM-5 Zeolite. Silicalite-1, an aluminum-free derivative of the ZSM-5 Zeolite, which has the strongest molecular attraction towards hydrocarbons, gave rise to better hybrid membrane selectivity than ZSM-5. However, impurities coming from the raw materials are generally present in synthesized silicalite-1 and cause a loss in the Zeolite attraction to hydrocarbon compounds. When such residual impurities are eliminated through acid and hydrothermal treatments, the silicalite hydrophobicity and, consequently the hybrid membrane selectiveness, increase. In addition to the hydrophobicity, the Zeolite pore size must be the other concerning factor that dominates hybrid membrane performances.

Furthermore, hydrophilic Zeolite NaY, which belongs to faujasite FAU type matrix has a 12-oxygen ring and a pore extent of 0.8 nm and has much larger pore size than the common silicalite with 0.6 nm pore and 10-oxygen ring. Used as a filler in its hydrophobic form, one can anticipate to sieve larger molecules or to have larger flux, compared with conventional silicalite-filled membranes. In general, the Si/Al ratio of the Zeolite has a strong influence on the capacity of polar molecule sorption.

For use with the present invention, hydrophobic Zeolites Y were prepared by increasing the Si/Al ratio. To obtain the highest Si/Al ratio, two conventional chemical treatments were combined, the SiCl4 treatment and the hydrothermal treatment. The structure of the obtained silicalites Y was studied with different techniques and their characteristics in sorption and desorption of water and hydrocarbons were determined.

Hybrid Zeolite Silicone Membrane, Powder Preparation:

In accordance for utilization with the present invention, a NaY Zeolite powder was obtained via Zeolyst with a Si/Al ratio of 2.5. The first step was the conversion of the hydrophilic NaY to a hydrophobic one. The hydrophilic NaY was first dehydrated at 300° C. under a nitrogen atmosphere, and then contacted with a SiCl4 saturated nitrogen stream at a flow ratio of 100 mL/min for 6 hours, thereby elevating temperatures from 125° C. to 300° C. Next, the chemically treated Zeolite was flushed with dry nitrogen at 300° C. for 6 hours to eliminate all residual reactant and gaseous reaction product, and then cooled down to ambient temperature and washed with distilled water until pH=7. In this particular application, silicon enriched Zeolite Y is termed ZSY5. When the ZSY5 sample is hydro thermally treated at 800° C. for 6 hours, a second version of ZSY6 is attained.

Hybrid Zeolite Silicone Membrane, Process Preparation:

The size of a FAU Zeolite is about 1 m, and is very hard to disperse, especially in high loading amount. Therefore, only a 5% filled hybrid membrane was prepared. In accordance with the present invention, the membrane is prepared as follows: First, the Zeolites were dehydrated at 500° C. for 5 hours before use. Next, 95 parts of a two component PDMS silicone, 5 parts of Zeolite, and 150 parts of solvent were mixed in a polyethylene container until a homogeneous suspension was obtained. Next, the suspension was then cast on a polyester film with a knife, and was left at ambient temperature for 36 hours for curing. The obtained composite membrane of 200 μm thick was evaluated in pervaporation without further treatment.

Hybrid Zeolite Silicone Membrane, Sorption and Pervaporation:

An examination of the cross-section of a filled hybrid membrane was evaluated with the following results. First, there were no discernable aggregates of the Zeolite particles and the adhesion between the silicone and Zeolite particles exhibited excellent adhesion. There was no apparent visible void space around the particles. The sorption isotherms of hydrocarbons in pure PDMS silicone membrane and Zeolite-filled hybrid membranes were apparent. Zeolite particles, due to its high sorption capacity, increased the sorption quality of the hybrid membranes. In addition, the Zeolite particles also act as physical crosslinks of the silicone polymer, thereby reinforcing its elastic forces and its resistance to swelling by hydrocarbon sorption. The final sorption capacity of filled membranes resulted due to a balance of these qualities.

The data displays that filled hybrid membranes sorb more hydrocarbons than the pure silicone membranes, with the highest sorption exhibited in the NaY—Zeolite-filled hybrid membrane. The silicone hybrid membranes selectively loaded with the ZSY5 and ZSY6 zeolites absorb less water than the pure silicone membrane. Therefore, the incorporation of hydrophobic Zeolites into silicone material enhances the materials sorption selectivity and sieving, thereby enhancing the hydrocarbon sorption while reducing water sorption. The sorption extent of hydrocarbons in the composite hybrid membrane depends not only on the pore volume of the used Zeolite, but also on its hydrophobicity. The concluding property is probably the main factor for the selectivity change, as the water sorption is radically reduced when the Si/Al ratio increases.

Zeolite Silicone Membrane (ZSM) Flow Cell Gas Extraction Technique:

According to one embodiment of the present invention, utilizing the innovative ZSM, as described above, in a gas extraction sieve mode, the ZSM provides unique reinforced integrity and support via the membrane's inner-layered titanium mesh. In addition, anti-fouling capabilities are achieved via an outer-layer of Teflon mesh.

The ZSM flowcell is operated in a differential pressure permeation mode of extraction, by maintaining a 1-5 psi differential across one side of the membrane via either positive or negative constant air flow as described in detail above. This differential flow accelerates the gas extraction transport across the membrane to the sensor side 315 (see FIG. 4). In some applications a thermo-acoustic membrane layer may be incorporated to further stabilize and enhance the gas transport across the membrane structure. According to the present invention, the ZSM flowcell can be utilized as a gas extractor from mediums such as air, liquid, foams and solids but should not be limited to such mediums by this disclosure. By nature of design the ZSM flowcell can be incorporated in various open as well as closed loop process environments with nominal intrusions.

According to the present invention, an additional property provided is the fast response time and molecular selectivity natures, thereby allowing increased quantitative/qualitative analysis of gas sensed. The ZSM flowcell design can be directly coupled with any gas sensor that utilizes IR/infra-red, UV/fluorescence, ME/mos-electron, or TC/thermo-catalytic for the measurement and analysis of various mediums.

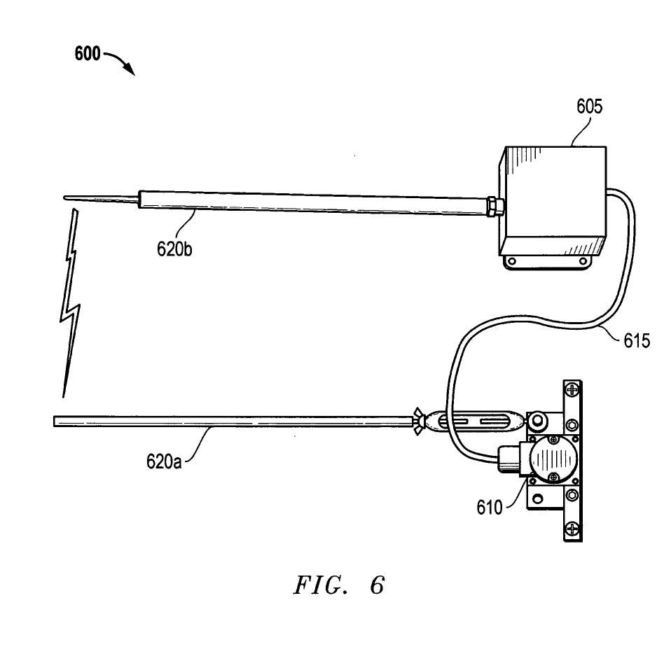

Now referring to FIGS. 6 and 7, wherein as part of the detection process by an infrared technique, gasses are subjected to infrared emitted energy that excites the gasses at a molecular level. As the gas molecules vibrate, they absorb/lose a portion of the emitted infrared energy. This loss or absorbed energy is monitored by an infrared sensor. Different gasses absorb infrared energy at unique levels specific to that particular gas, allowing a correlation between different gas types as well as volumetric quantities of 0%-gas to 100%-gas.

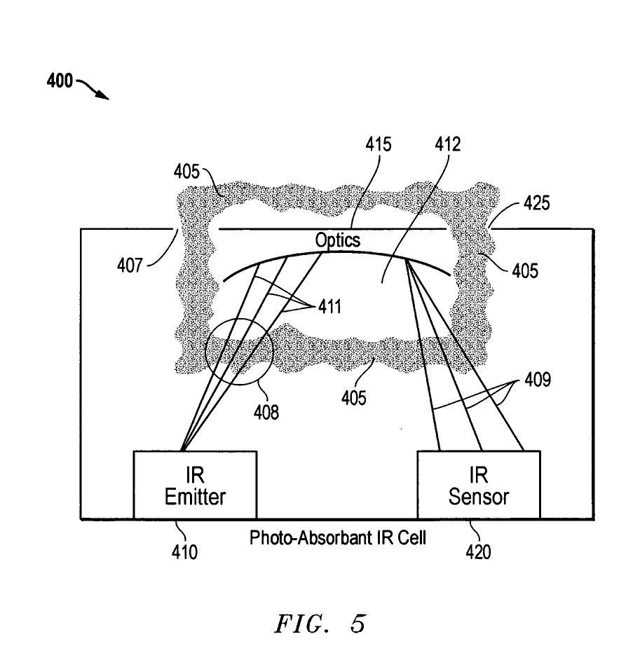

According to the present invention a miniature silicon photo-absorbent infrared (IR) cell 400 and its utilization in a non-conventional mud-gas sensing concept is presented. The infrared cell 400 described provides low cost and reliable mud-gas sensors to the industry. Typical infrared (IR) systems for sensing gas concentrations in air consists of a thermal black body radiation emitters, an absorption path, optical element, and an IR detector. However, the specific IR flow cell 400 system for sensing gas concentrations of the present invention consists of a micro-machined infrared emitter 410, an absorption path 408 and a photosensitive IR sensor 420 with a built-in thermopile. Additionally, cell 400 comprises an inlet orifice 407 formed within the flow cell 400 to permit the inflow of gas 405 into an absorption chamber 412 formed within the flow cell 400. Additionally, cell 400 further comprises an exit orifice 425 to permit gas 405 to exit the absorption chamber 412. Although not graphically shown in FIG. 5, the IR flow cell further comprises an electrical interface provided on the IR cell 400 to allow for interface with the gas extraction system 1 components as described in FIGS. 1 and 2.

According to the present invention, emitter 410 is modulated at a frequency of about 4-10 Hz, emitting infrared light 411 with an approximate black body spectral distribution. The actual presence of a gas 405 in the absorption path 408 reduces the light intensity at gas specific absorption wavelengths. Before reaching the photosensitive IR sensor 420, the IR light 411 is optionally transmitted through a broadband specific pass interference optics filter 415, designed to let the transmitting band discriminate the absorption pattern of the target gas. Transmitted light 409 enters the photosensitive IR sensor 420 when the sensor 420 is filled with a target gas that is identical to the gas to be detected. Such response causes most of the light 409 corresponding to the gas specific absorption wavelengths to be absorbed in the enclosed IR cell 420.

The photo-acoustic gas sensing technique has been utilized in many various sensing applications. The general principle of a photosensitive gas sensor is as follows: When a gas is irradiated with infrared (IR) light it absorbs incident radiation within its own characteristic absorption spectrum. The amount of absorbed radiation, which follows the Beer-Lambert absorption law, is a function of the gas concentration, the path length and the specific absorption coefficient of the gas. This absorbed radiation, which for a very short period of time is stored as intra-molecular vibrational and rotational energy, is quickly released by relaxation to translational energy. Translational energy is equivalent to that of heat and when the absorption chamber is exposed energy absorbance is caused to rise. Each gas 405 has a unique IR spectrum, and strong absorption takes place only at certain wavelengths. When the incident light 409 is modulated at a given frequency, a periodic energy change is generated in the absorption chamber 412. This photosensitive electric signal can be measured with a sensitive optical sensor, usually a thermopile (not shown).

In a conventional photosensitive sensor, the gas to be analyzed is sampled into an absorption chamber 412 during the measurement. The cell is irradiated with modulated IR light filtered at the wavelengths at which the gases of interest absorb strongly. According to the present invention, as shown in FIG. 5, the photosensitive IR gas sensor 420 is sampled with the actual target gas and then sealed. When modulated IR light 409 is passed into the absorption IR sensor 420, a photoelectric signal is generated. If the sample gas is introduced in the absorption path 408 outside the cell, a reduction of the cell electric signal is observed. This reduction is nearly proportional to the concentration of target gas in the absorption path 408.

According to the present invention, it should be understood that a signal reduction is observed only if the gas inside the sensor cell 420 is absorbing IR radiation at the same wavelength as the filter 415. In this way, a high selectivity can be obtained without the use of any additional optical filtering 415. The gas 405 inside the absorption sensor 420 cell acts as a band selective filter itself.

Now referring to FIG. 6, in accordance with one embodiment of the present invention, a remote encoder module component 600 apparatus is provided for linear depth tracking for gas data correlation data encoding. The remote encoder module component 600 apparatus of the present invention comprises a stainless steel control box enclosure 605 for housing battery and radio frequency transceiver modem electronics (not shown). The module 600 further comprises an electronic radio frequency transceiver modem for bi-directional control and encoder data acquisition, an electronic RF modem sub-assembly board to provide a signal conversion and conditioning interface to the encoder interfaces (not shown), an optical rotary encoder 610 (described in detail below) that provides bi-directional rotary translational data relative to drill movement, an electronic sensor conditioning micro-processor board (not shown) mounted inside the encoder 610 to provide power to the sensor 35 and to electronically condition the sensor signal, digitally store sensor 35 data, correct for environmental variables and further digitize the signal for transmission.

In addition, the component module 600 includes a four-wire communication cable 615 and connectors to connect the encoder 610 to the stainless steel control box 605, a plurality of switches, lights and connectors to provide manual user control of system, a pair of remote mount high gain antenna 620a, 620b for RF signal, a plurality of software program modules for providing microprocessor functionality control and user interface functionality and control, and a mechanical tri-track wheel assembly to provide mounting and a mechanical interface between the rotary encoder 610 and the process line.

As described, the remote encoder modular component 600 described utilizes a stainless steel enclosure 605 similar to that utilized with the gas sensing unit 10 as described in FIG. 2 to house the components listed above. The encoder module 600 is designed, according to an embodiment of the present invention, to operate as a stand-alone remote module for the purpose of relaying remote “depth X-axis” information, which is incorporated with the gas data derived from the gas sensing system 1 as described in FIG. 1. This information is incorporated with the derived gas data for well depth correlation in addition to existing date-time correlation information.

An example of the incremental rotary encoder 610 as utilized within the remote encoder module component 600 apparatus of the present invention is available from Miranova Systems, Inc. of San Luis Obispo, Calif. and having a part number of SE-501. The specifications regarding an example of the rotary encoder utilized are as follows:
Rotating shaft seal
Two channels in quadrature plus an index and complements (ABZC)
Multi-voltage line driver (7272 operates at 5-24 VDC: TTL compatible at 5 volts)
Sealed, 10-pin MS-style connector with threaded shell

The encoder 610 utilized in one embodiment of the present invention provides an output having two channels in quadrature with ½ cycle index gated with negative B channel as standard. In addition, the encoder utilized is capable of 1 to 2,048 cycles per shaft turn.

In broad descriptive, incremental rotary encoders are designed to provide a series of periodic signals due to mechanical motion. The number of successive cycles (signals) corresponds to the resolvable mechanical increments of motion. The signal provides logic states “0” and “1” alternately for each successive cycle of resolution. Rotary encoders are multi-turn sensors utilizing optical, mechanical, or magnetic indexing around the circumference of rotation. For example, optical encoders utilize a transmitter-receiver set to count the opaque lines and thus the angular increment. Multiple transmitter-receiver sets may be arranged to provide multiple counts per line. One common technique is to offset two sets a half line-width apart. This results in four counts per line. This technique of enhancing resolution via out-of-phase signals is known as quadrature. Quadrature signals are analog outputs that involve two channels 90° out of phase (quadrature).

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A system for extracting, sensing, and analyzing gas within a gas-containing media matrix, the gas comprising one or more gases, the system comprising:
a supported membrane extraction probe for point contact extraction of gas from within the gas-containing media matrix;
a means for facilitating the transport of gas extracted by the membrane extraction probe;
a gas sensing means for sensing and correlating data values related to a gas within the extracted gas transported by the means for facilitating the transport thereof, wherein the sensing means further electronically transfers the data values to at least a digital conditioning means; and
a wireless transceiver for communicating the gas-sensed data values to a remote receiving transceiver, wherein the transceiver is connected to a power source, wherein the remote receiving transceiver is communicably interfaced with a microprocessor for data logging.

2. The system of claim 1 wherein the power source is an internal battery source.

3. The system of claim 1 wherein the power source is selected from the group consisting of solar power, AC power, or external DC battery power.

4. The system of claim 1 wherein the membrane is composed of a semi-permeable hydrophobic polydimenthyl siloxane (PDMS) silicone.

5. The system of claim 4 wherein the membrane is supported by a first mandrel and inserted into a cylindrically shaped stainless steel machined mandrel housing defining the extraction probe.

6. The system of claim 5 wherein the cylindrically shaped stainless steel second mandrel housing comprises a plurality of flow channels, wherein the channels permit gas-from-media flow extraction.

7. The system of claim 1 wherein the extraction probe is attached to a gas sensing means via a removably attached rubber hose.

8. The system of claim 7 where the hose further functions to protectively enclose a plurality of stainless air flow supply and gas return lines.

9. The system of claim 8 wherein the gas return lines produces extracted gas to a gas sensing means.

10. The system of claim 1 wherein the means for facilitating the transport of gas is an air transfer pump having air and gas transfer lines removably attached thereto.

11. The system of claim 1 wherein the extraction probe can be utilized in a closed loop system for gas extraction therefrom.

12. The system of claim 10 wherein the air transfer pump provides an air circulation stream across the silicone membrane in the probe.

13. The system of claim 12 wherein the pump further provides a circulation stream of extracted gas.

14. The system of claim 13 wherein the circulation stream of extracted gas is provided to a gas sensing means.

15. The system of claim 14 wherein the gas sensing means is an IR emitter and absorption gas sensor.

16. The system of claim 15 when the emitter is modulated at a frequency in the range of about 4-10 Hz, wherein the emitted light has an approximate black body spectral distribution.

17. The system of claim 1 wherein a wireless transceiver is a digital RF modem.

18. The system of claim 1 where the receiving transceiver is a remote wireless transceiver RF modem.

19. The system of claim 18 wherein the remote wireless transceiver RF modem is communicably connected to a microprocessor for data logging to permit permanent media storage display monitoring and/or printer plotting.

20. An apparatus for extracting, sensing, and analyzing gas within a gas-containing media matrix, the gas comprising one or more gases, the apparatus comprising:
a cylindrical housing, wherein the housing comprises a plurality of flow channel slots;
a means for extracting a gas from a gas-containing liquid from a media, wherein the means for extracting is in flow communication with the cylindrical housing, such that the housing and means for extracting provide point contact extraction of gas from within the gas-containing media matrix;
a plurality of transfer tubes in flow communication with the means for extracting;
a means for facilitating the transport of gas from the means for extracting;
an IR emitter and absorption gas sensing means which generates an electrical signal corresponding to the light absorption for sensing and correlating data values related to a target gas within the extracted gas transported by the means for facilitating the transport thereof, wherein the sensing device further electronically transfers the data values to at least a digital conditioning means; and
a wireless transceiver for communicating gas-sensed data to a receiving transceiver, wherein the transceiver is communicably interfaced with a microprocessor for data logging.

21. The apparatus of claim 20 wherein the cylindrical housing is a stainless steel machined mandrel.

22. The apparatus of claim 20 wherein the means for extracting is a support mandrel covered by a membrane.

23. The apparatus of claim 22 wherein the membrane is a polydimenthysiloxane (PDMS) silicone membrane.

24. The apparatus of claim 23 wherein the silicone membrane material is processed in a plurality of thicknesses, wherein various thicknesses are chosen to improve selectivity to hydrocarbons.

25. The apparatus of claim 24 wherein the membrane is a hybrid Zeolite filled silicone membrane.

26. The apparatus of claim 25 wherein reinforced support and anti-fouling properties are provided.

27. The apparatus of claim 26 wherein the reinforcement properties are achieved via an inner layer of titanium mesh within the membrane.

28. The apparatus of claim 26 wherein the anti-fouling properties are achieved via an outer-layer of Teflon® mesh.

29. The apparatus of claim 22 wherein gas extraction and separation via the membrane is accomplished through pervaporation.

30. The apparatus of claim 29 wherein the membrane acts as a molecular sieve.

31. The apparatus of claim 20 wherein the plurality of transfer tubes provides air and extracted gas circulation.

32. The apparatus of claim 20 wherein the means for facilitating the transport of gas from the means for extracting is a transfer pump.

33. The apparatus of claim 31 wherein a media matrix is maintained at atmospheric pressure on the upstream side of the membrane, wherein gas is extracted as a vapor because of an induced low vapor pressure on the downstream side.

34. The apparatus of claim 33 wherein the transfer pump provides the necessary pressure for gas extraction.

35. The apparatus of claim 20 wherein the transfer tubes are manufactured of a stainless material and are protectively enclosed within a rubber hose housing.

36. The apparatus of claim 20 wherein the means for facilitating the transport of gas is an air transfer pump having a plurality of connections for removable attachment of air and gas transfer tubes thereto.

37. The apparatus of claim 20 wherein the apparatus is utilized in an open system for gas extraction therefrom.

38. The apparatus of claim 20 wherein the apparatus is utilized in a closed loop system for gas extraction therefrom.

39. The apparatus of claim 36 wherein the pump facilitates an air circulation stream across the silicone membrane within in a probe.

40. The apparatus of claim 39 wherein the pump further facilitates a circulation stream of extracted gas from the probe.

41. The apparatus of claim 40 wherein the circulation stream of extracted gas is provided to a gas sensing means.

42. The apparatus of claim 20 wherein the gas sensing means is an IR emitter and absorption gas sensing device.

43. The apparatus of claim 42 wherein the emitter is modulated at a frequency in the range of about 4-10 Hz, wherein the emitted light has an approximate black body spectral distribution.

44. The apparatus of claim 20 wherein the wireless transceiver is a digital RF transceiver modem.

45. The apparatus of claim 20 wherein the receiving transceiver is a remote wireless digital spread spectrum bi-directional transceiver RF modem.

46. The apparatus of claim 45 wherein the remote wireless transceiver RF modem is communicably connected to a microprocessor for data logging to permit permanent media storage, display monitoring, and/or printer plotting.

47. A stand-alone remote encoder module component apparatus for facilitating linear depth tracking for gas data correlation and encoding purposes, the apparatus comprising:
a housing;
a power source disposed within the housing;
a transceiver in operational connectivity with the power source, wherein the transceiver comprises at least a sub-assembly board, wherein signal conversion and encoder interface is accomplished;
an optical encoder in operative communication with the transceiver;
an antenna for conducting communications with the encoder, wherein encoder data is transmitted via the antenna to a microprocessor for data logging.

48. The apparatus of claim 47 wherein the housing is constructed of a stainless metal material.

49. The apparatus of claim 47 wherein the encoder functions to relay remote depth X-axis information for correlation with gas data, wherein the gas data is derived from a gas sensing and detection system.

50. The apparatus of claim 49 wherein the encoder further provides bi-directional rotary translational data, wherein the data is relative to drill movement.

51. The apparatus of claim 47 wherein the encoder provides an output having two channels in quadrature with half-cycle index gated and having negative B-channel as standard.

52. The apparatus of claim 51 wherein the encoder is capable of cycles per shaft in the range of 1 to 2048 turns.

53. The apparatus of claim 47 wherein the power source is a battery.

54. The apparatus of claim 47 wherein the transceiver is an electronic RF transceiver modem for bi-directional control and data acquisition.

55. A method for extracting, sensing, detecting, measuring, and analyzing gas within a gas-containing media matrix, the gas comprising one or more gases, the method comprising:
providing a gas-containing media;
providing a membrane gas extraction means;
inserting the gas extraction means into the gas-containing media;
extracting target gases from the media;
providing an internal gas sensing and detection means;
transporting the extracted target gases to the internal gas sensing and detection means;
subjecting the extracted gases to IR emitted energy by the sensing and detection means;
sensing and detecting the extracted gases;
transferring electronically sensed gas value data to a digital conditioning means, wherein the conditioning means corrects the values for erroneous variables, scales the values to a common engineering unit and digitizes the values for wireless communication;
encoding the digitized values for correlation of the sensor data, and
communicating the digitized sensed gas data via a transceiver to a receiving transceiver for communication to a microprocessor for further data logging.

56. The method of claim 55 wherein the gas containing media comprises a returning mud flow matrix associated with drilling operations.

57. The method of claim 55 wherein the gas containing media is selected from the group consisting of air, liquid, foam, and solids.

58. The method of claim 55 wherein the membrane gas extraction means is a hydrophobic polydimenthyl siloxane silicone membrane.

59. The method of claim 55 wherein the membrane is a Zeolite filled silicone membrane.

60. The method of claim 55 wherein the step of inserting is accomplished by manual means.

61. The method of claim 55 wherein the step of extracting target gases is facilitated by an air transfer pump providing air circulation to the membrane and providing transfer circulation of the extracted gas to a gas sensing means.

62. The method of claim 55 wherein the internal gas sensing and detection means is an IR emitter and absorption gas sensor.

63. The method of claim 55 wherein the transporting step the extracted gas flow to the gas sensing and detection means is accomplished via a transfer pump and tube combination.

64. The method of claims 55 wherein the step of communicating to a receiving transceiver is accomplished via spread-spectrum RF bi-directional communications.
